(19) United States
(12) Patent Application Publication
(10) Pub. No.: US 2004/0063550 A1
(43) Pub. Date: Apr. 1, 2004

(54) Mobile body suspension exercise device

(76) Inventor: Robert D. Harris, Logan, UT (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/621,118

(22) Filed: Jul. 15, 2003

Related U.S. Application Data
(60) Provisional application No. 60/397,484, filed on Jul. 19, 2002.

(51) Int. Cl. A61H 3/00; A47D 13/04; A63B 22/00; A63B 71/00

(52) U.S. Cl. 482/69; 482/74

(57) ABSTRACT

An exercise device includes a frame typically an arching member extending between generally parallel lower members having wheels operably coupled thereto. A harness extends from the frame, and the height of the harness is selectively adjustable by a user within the harness. A controller accessible to a user activates a motor and raises and lowers a cable to adjust the height of the harness, and thus the weight load on the user's feet while operating the device. A handlebar extends to one or more of the wheels for selectively steering the device. A brake system accessible to the user enables stopping of the device. The device may include a motor operably coupled to a wheel for propelling the device, and a throttle control for selecting the speed of the motor. Thus, the user of the device can selectively alter the impact weight and speed while operating the device.

### RELATED APPLICATION

This application claims priority from U.S. Provisional Application Serial No. 60/397,484, filed Jul. 19, 2002.

### BACKGROUND OF THE INVENTION

The present invention relates generally to exercise devices. More particularly, the present invention relates to a mobile body suspension exercise device which attaches to and exerts an upward force on an individual, thereby allowing the individual to walk, jog, or run under a reduced weight load.

Traditionally, body suspension devices have been employed to assist physically challenged or impaired persons in walking. These devices generally employ a harness that attaches to a user and a means for exerting an upward force on the harness, thereby supporting a portion of the user's bodyweight so that he or she may walk under a reduced weight load. However, there are several important drawbacks to traditional body suspension devices.

Many body suspension devices require the concurrent use of a treadmill. Such an exercise system is disclosed in U.S. Pat. No. 6,273,844. In addition to the fact that a treadmill assembly greatly increases the overall cost of these body suspension devices, such an arrangement also confines the user to a single location, usually indoors, during exercise.

Other body suspension devices do not require the use of a treadmill, but nevertheless confine the user to a single location because the devices are either extremely heavy, immobile, and designed so as to require the user to walk in circles, or require the use of stationary overhead guide cables or other mounting devices which confine the user to a single narrow path wherein the range of travel is limited by the length of the cables or other mounting devices. Such a system is disclosed in U.S. Pat. No. 5,997,444.

Still other body suspension devices suspend the user from a mobile, wheeled frame, thereby freeing the user from locational constraints. However, these devices permit only light exercise activity. Neither the frames themselves nor the wheels are designed to enable the user to jog or run. The frames generally have high centers of gravity, thereby substantially increasing the likelihood of tipping over and injuring the user during jogging or running. The wheels are small and not designed to travel over the rough surfaces normally encountered on tracks, sidewalks, and roads. U.S. Pat. Nos. 2,719,568; 3,778,052; 5,526,893; and 5,603,677 disclose such devices. An additional drawback of such devices is that the user, typically held in a harness or the like, is unable to adjust the tension of the harness to load or unload his or her weight during operation of the device. Thus, users of such devices must pre-tension and adjust the harness before using the same. Moreover, these devices are limited to assisting the severely injured and rehabilitating user in merely walking, not running or jogging.

Arguably the most substantial drawback common to traditional body suspension devices is that they do not address the needs of individuals who are not severely injured. For instance, many individuals are not injured at all, but desire to run or jog outdoors for exercise without the knee, ankle, back, and hip stress normally associated with high-impact activities. Many other individuals have suffered only mild injuries which would not prevent them from jogging or running outdoors for exercise if a portion of their bodyweight could be supported. Even those body suspension devices that permit a user to travel freely outdoors are designed only to assist relatively seriously injured or impaired persons in walking. They will not accommodate a user desiring to jog or run.

Accordingly, there is a need for a body suspension device which is mobile and travels with a user during exercise; which exerts an upward force on the user, thereby supporting a portion of the user's bodyweight and allowing him or her to exercise under a reduced weight load; which does not require the use of a treadmill, but allows the user's feet to touch the ground; and which permits the user to walk, jog or run at any pace, without locational restraints, and over a variety of rough surfaces normally encountered outdoors. There is also a need for a body suspension exercise device which enables the user to adjust the loading of the body weight during operation of the device. Furthermore, it would be advantageous to provide such a device which could be self-propelled so as to pace the running of the user. The present invention fulfills these needs and provides other related advantages.

### SUMMARY OF THE INVENTION

The present invention resides in a mobile suspension exercise device which travels with the user during exercise and exerts an upward force on the user thereby supporting a portion of the user's body weight and allowing him or her to exercise under reduced weight load. The exercise device of the present invention allows the user to walk, jog or run at any pace, without locational restraints, and over a variety of rough surfaces normally encountered outdoors.

The exercise device generally comprises a frame having a plurality of wheels. Typically, the frame comprises an arching member extending between generally parallel lower members having the wheels operatively coupled thereto. Preferably, the wheels are adapted for use outdoors or on uneven surfaces.

A body lift system includes a harness extending from the frame. Typically, the body lift system includes a support frame attached to the arching member, above the harness. The height of the harness is selectively adjustable by a user wearing the harness. A handlebar extends to one or more of the wheels for selectively steering the device. The body lift system includes a cable of adjustable length coupled to the harness. Typically, one or more springs interconnect the harness and the cable.

In a particularly preferred embodiment, a motor is operably coupled to the cable for raising and lowering the harness. Typically, a winch is operably connected to the motor and cable for adjusting the length of the cable in response to actuation of a controller accessible to the user which activates the motor, and thus the winch.

Another motor may be operably coupled to a wheel of the device for propelling the device. Preferably, a throttle control is accessible to the user for selecting the speed of the motor, and thus the device.

The device also preferably includes a brake system, including a brake operably connected to at least one wheel and a brake actuator accessible to the user to enable the user to stop the device.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a front perspective view of a mobile body suspension exercise device embodying the present invention;

FIG. 2 is a front perspective view similar to FIG. 1, illustrating front wheels thereof turned;

FIG. 3 is an enlarged and partially fragmented perspective view of a handlebar and various controllers of the device; and

FIG. 4 is a side elevational view of the device of the present invention operated by a user, shown in phantom, strapped into a harness thereof.

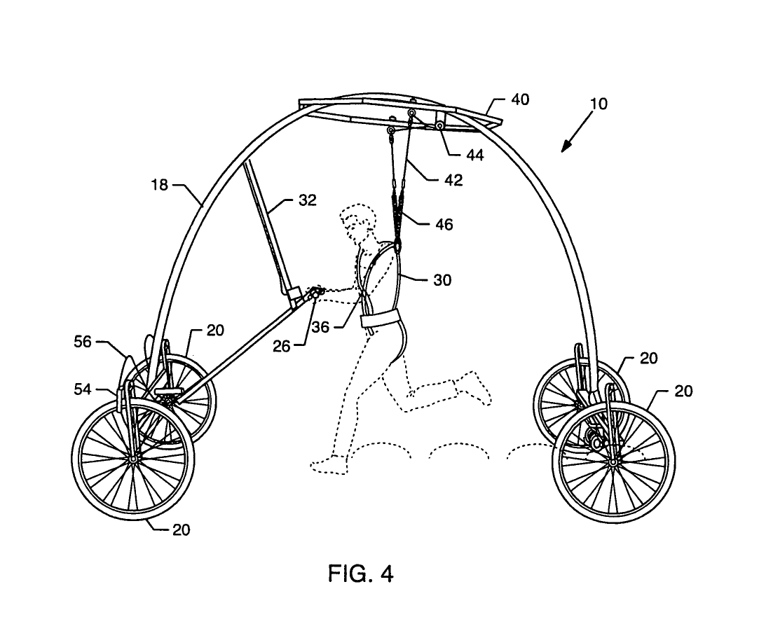

### DETAILED DESCRIPTION OF THE PREFERRED EMBODIMENTS

As shown in the drawings for purposes of illustration, the present invention resides in a mobile body suspension exercise device, referred to generally by the reference number 10, capable of suspending a portion of a user's bodyweight during walking, jogging, or running.

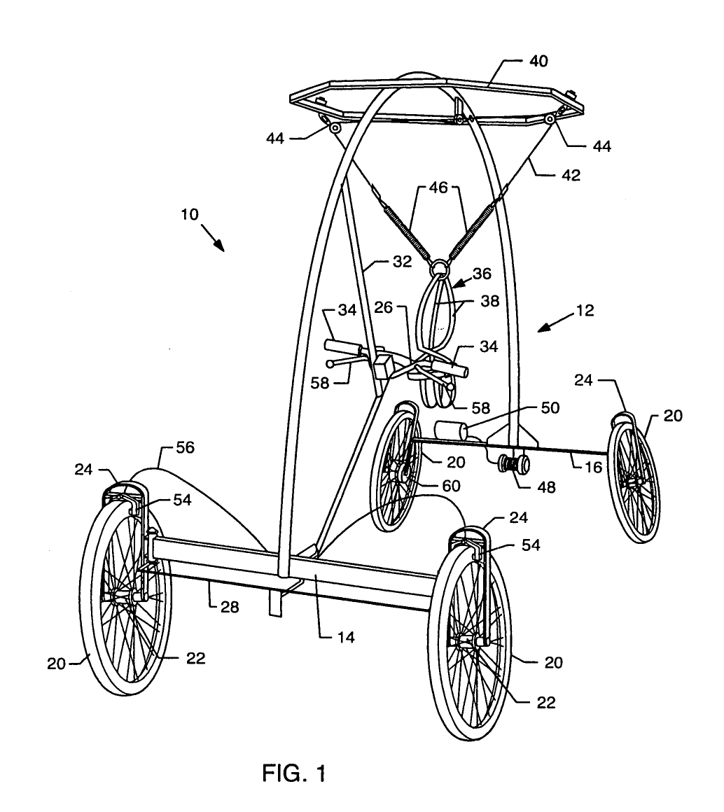

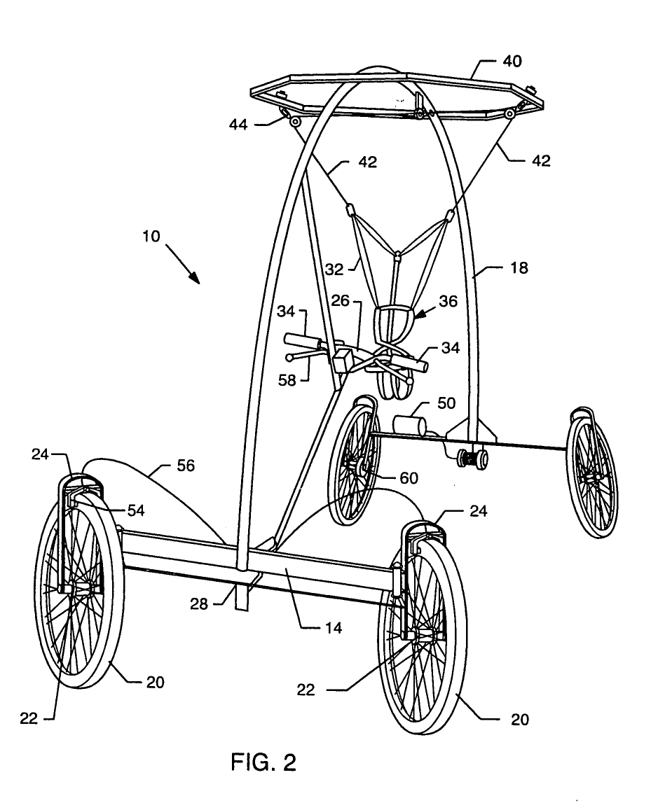

With reference now to FIGS. 1 and 2, the exercise device 10 includes a frame 12 including generally parallel front and back lower members 14 and 16. A generally arched member 18 extends between the lower members 14 and 16. Of course, it will be understood by those skilled in the art that other frame configurations are possible, the object of the present invention being to provide sufficient space and to allow a user of the device 10 to walk, run, or jog unimpeded. The arch member 18 is sufficiently high at its apex so as to allow a runner of even a fairly large height to run unimpeded in the device 10. Thus, the distance between the apex of the arch member 18 and the ground is typically seven feet or more.

Wheels 20 are operably coupled to the front and back lower members 14 and 16 so that the device 10 can be freely moved. Preferably, the wheels 20 are relatively large and composed of a material suitable for travel over pavement, asphalt, roads, sidewalks and other outdoor and uneven surfaces normally encountered during walking, jogging and running. It has been found that bicycle wheels are particularly useful as they are fairly large and sufficiently durable for operation outdoors and on uneven surfaces. This frees the user from locational restraints while exercising, and likewise removes limitations on the amount of exertion the user can put forth during exercise. As few as three wheels 20 may be utilized, with a single wheel disposed at either the front or rear of the device 10, but in a particularly preferred embodiment a total of four wheels, one wheel disposed at the free end of each lower member 14 and 16 is used for stability purposes. Each wheel 20 spins on its own axle 22 which is connected to a wheel frame 24 that is attached to an end of the lower crossbar members 14 and 16.

In the illustrated four-wheel embodiment, the front wheel frames 24 are pivotally connected to the front lower crossbar member 14 to allow steering of the device 10. Handlebars 26 extend from a linkage bar steering system 28 that is operably coupled with the front one or more wheels 20 such that as the handlebars are turned, the front one or more wheels 20 similarly turn to steer the device 10. Preferably, the handlebars 26 extend inward of the device 10 such that they are readily accessible to a user of the device 30. Due to its elongated nature, the handlebar 26 may be supported by a cable or support bar 32, which holds the handlebar 26 upright, and also enables it to be adjusted in height relative to the user 30 of the device 10. Preferably, the handlebars 26 include hand grips 34 to facilitate the grasping and steering of the handlebars 26, in traditional fashion.

The device 10 includes a body lift system which is used to raise and lower the user 30 and thus suspend whatever portion of his or her bodyweight that the user wishes, up to one-hundred percent of the user's bodyweight, thus reducing the impact and the attendant injuries of pounding against asphalt and other hard surfaces upon which the user 30 is walking, jogging or running. The body lift system of the present invention includes a body harness 36 comprised of a number of straps 38 which are configured to extend around and attach to the user's trunk, waist, and upper legs. A support frame 40 is positioned above the user 30 and attached to, or otherwise formed with, an upper portion of the arched frame member 18. The support frame 40 supports an adjustable cable 42 which extends through various eyelets or pulleys 44 attached to the support frame 40 for supporting the harness 36 in a suspended state. The cable 42 may be directly attached the harness 36, as illustrated in FIG. 2, but in a particularly preferred embodiment springs 46 interconnect the cable 42 and harness 36 so as to provide additional flexibility and cushion to the running user 30. The support frame 40, illustrated as being generally circular in configuration, extends outwardly from the arch member 18 so as to properly position the cables 42 in order to support the user 30 within the harness 36, and adjust the height of the harness 36, and thus unload or load the user's weight, as described above.

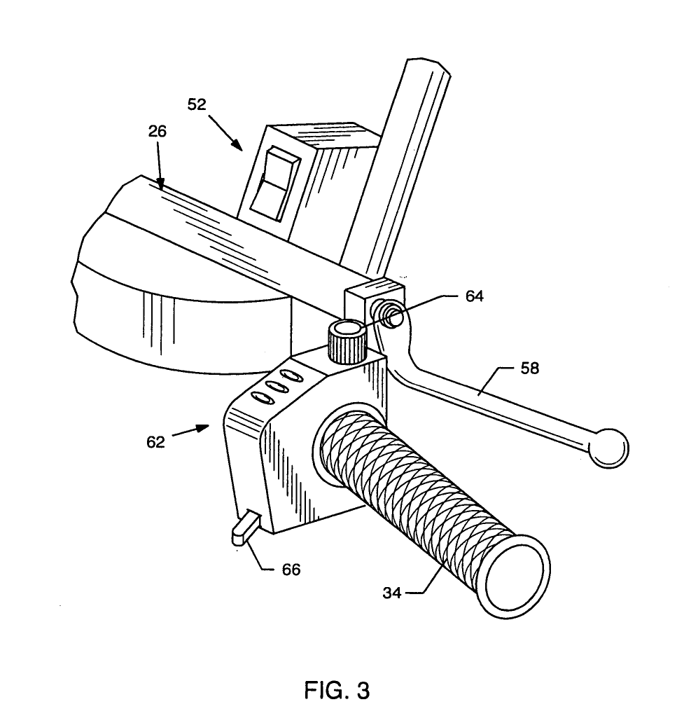

In a particularly preferred embodiment, the user 30 has access to a control mechanism for raising and lowering the harness 36 via the cables 42 while operating the device 10. This is typically accomplished using a motorized winch 48 having an electric power source in the form of a battery 50 for adjusting the length of the cable 42, and thus the height of the harness 36. With particular reference to FIG. 3, within grasp of the user 30, and typically disposed on the handlebar 26, a controller 52, including a toggle switch or the like, can be used to activate the motorized winch 48 and raise or lower the harness 36 while operating the device 10. In this manner, a runner could suspend substantially all of his or her bodyweight at the beginning of a run, and subsequently lower the harness 36 after warming up. Alternatively, if a user has bad joints or a bad back, the user 30 may actually raise the harness 36 if experiencing discomfort so that the impact on these joints and body areas is reduced while walking, jogging or running.

With reference to FIGS. 1-3, the device 10 preferably includes a brake system to allow the user 30 to slow the device 10 as well as to stop the device 10 as necessary. As such, brakes 54, such as caliper-type bicycle brakes are associated with one or more wheels 20 and include brake cables 56 which extend to brake levers 58 attached to the handlebar 26 so as to be readily accessible by the user 30.

With continuing reference to FIGS. 1-3, the device 10 may include a motor 60 which is operably connected to at least one axle 22 of one wheel 20 so as to selectively propel the device 10 forward. Such electric motors 60 are well-known in the art and used in electrical bicycles, scooters and the like. The motor 60 would be operably coupled to the battery 50, and an electrical lead would extend therefrom to a throttle control 62 accessible to the user, such as on or near the handlebar 26. With particular reference to FIG. 3, the throttle controller 62 could include an on/off switch 64 to activate or deactivate the motor 60, as well as a throttle control 66 which could be built into the hand grip 34 or comprise a switch or the like so that the user could increase the power and speed of the device 10 at will while operating the device 10. Use of the propelling motor 60 in the device 10 can be used, similar to a treadmill, to provide a predetermined pace that the user 30 must maintain while running or jogging. The motor 60 could also be used to propel the device 10 in the event that the user 30 is having difficulty propelling the device 10 forward by simply walking or running.

It will be appreciated by those skilled in the art that the exercise device 10 of the present invention can assist those of varying ability. Those with attendant injuries or problematic joints and the like can use the device 10 of the present invention to unweight and suspend their body to lessen the impact while walking, running and jogging. Those of greater athleticism can use the device 10 of the present invention to length their stride and maintain a fast running pace while exercising outdoors.

Although several embodiments have been described in detail for purposes of illustration, various modifications may be made without departing from the scope and spirit of the invention. Accordingly, the invention is not to be limited, except as by the appended claims.

What is claimed is:

1. A mobile body suspension exercise device, comprising:
a frame having a plurality of wheels;
a body lift system including a harness extending from the frame, the height of the harness being selectively adjustable by a user therein;
a handlebar disposed adjacent to the user and extending to one or more of the wheels for selectively steering the device; and
a brake system including a brake operably connected to at least one wheel and a brake actuator accessible to the user.

2. The exercise device of claim 1, wherein the frame comprises an arching member extending between generally parallel lower members having the wheels operably coupled thereto.

3. The exercise device of claim 2, wherein the body lift system includes a support frame attached to the arching member above the harness.

4. The exercise device of claim 1, wherein the body lift system includes a cable of adjustable length coupled to the harness.

5. The exercise device of claim 4, including a motor operably coupled to the cable for raising and lowering the harness.

6. The exercise device of claim 5, including a winch operably connected to the motor and the cable for adjusting the length of the cable.

7. The exercise device of claim 5, including a controller accessible to the user for actuating the motor.

8. The exercise device of claim 4, including a spring interconnecting the harness and the cable.

9. The exercise device of claim 1, including a motor operably coupled to a wheel for propelling the device.

10. The exercise device of claim 9, including a throttle control accessible to the user for selecting the speed of the motor.

11. The exercise device of claim 1, wherein the wheels are adapted for use outdoors on uneven surfaces.

12. A mobile body suspension exercise device, comprising:
a frame having a plurality of wheels;
a body lift system including a cable of adjustable length extending from the frame and coupled to a harness;
a motor operably coupled to the cable;
a controller accessible to a user in the harness for actuating the motor to selectively raise and lower the harness to unload and load the weight on the user's feet while operating the device; and
a handlebar extending to one or more of the wheels for selectively steering the device.

13. The exercise device of claim 12, including a brake system having a brake operably connected to at least one wheel and a brake actuator accessible to the user.

14. The exercise device of claim 12, wherein the frame comprises an arching member extending between generally parallel lower members having wheels operably coupled thereto.

15. The exercise device of claim 14, wherein the body lift system includes a support frame attached to the arching member above the harness and supporting at least a portion of the cable.

16. The exercise device of claim 12, including a winch operably connected to the control device, motor and the cable, for adjusting the length of the cable.

17. The exercise device of claim 12, including a spring interconnecting the harness and the cable.

18. The exercise device of claim 12, including a motor operably coupled to a wheel for propelling the device.

19. The exercise device of claim 18, including a throttle control accessible to the user for selecting the speed of the propelling motor.

20. The exercise device of claim 12, wherein the wheels are adapted for use outdoors on uneven surfaces.

21. A mobile body suspension exercise device, comprising:
a frame having a plurality of wheels adapted for use outdoors or uneven surfaces;
a body lift system including a cable of adjustable length extending from the frame and coupled to a harness;
a motor operably coupled to the cable;
a controller accessible to a user in the harness for actuating the motor to selectively raise and lower the harness to unload and load the weight on the user's feet while operating the device;
a motor operably coupled to a wheel for propelling the device;
a throttle control accessible to the user for selecting the speed of the propelling motor;
a handlebar extending to one or more of the wheels for selectively steering the device; and
a brake system having a brake operably connected to at least one wheel and a brake actuator accessible to the user.

22. The exercise device of claim 21, wherein the frame comprises an arching member extending between generally parallel lower members having wheels operably coupled thereto.

23. The exercise device of claim 22, wherein the body lift system includes a support frame attached to the arching member above the harness and supporting at least a portion of the cable.

24. The exercise device of claim 21, including a winch operably connected to the control device, motor and the cable, for adjusting the length of the cable.

25. The exercise device of claim 21, including a spring interconnecting the harness and the cable.
